(19) United States
(12) Patent Application Publication
(10) Pub. No.: US 2024/0317173 A1
(43) Pub. Date: Sep. 26, 2024

(54) RECREATIONAL VEHICLE WITH A SEAT BELT BRACKET

(71) Applicant: HYMER GmbH & Co. KG, Bad Waldsee (DE)

(72) Inventors: Andreas Fiedler, Neu-Ulm (DE); Kai-Uwe Zitterell, Untermarchtal (DE); Hannes Hörmann, Bad Waldsee (DE)

(21) Appl. No.: 18/613,490

(22) Filed: Mar. 22, 2024

(30) Foreign Application Priority Data
Mar. 23, 2023 (DE) 10 2023 107 400.8

(51) Int. Cl. B60R 22/22; B60K 1/04; B60P 3/36; B62D 21/02; B62D 21/15

(52) U.S. Cl. CPC B60R 22/22; B60K 1/04; B60P 3/36; B62D 21/02; B62D 21/15; B60K 2001/0438

(57) ABSTRACT

A recreational vehicle, in particular a motorhome, has a vehicle frame and at least one belt support which is attached at least indirectly to the vehicle frame. A battery space is provided, which is arranged at least partially within the vehicle frame. The belt support is arranged at least partially above the battery space, and the belt support is connected to the vehicle frame in such a way that connecting elements, which serve to connect the belt support to the vehicle frame, are arranged outside the battery space.

### CROSS-REFERENCE TO RELATED APPLICATION

This application claims priority to German application DE 10 2023 107 400.8, filed Mar. 23, 2023, which is hereby incorporated by reference in its entirety.

### FIELD OF THE INVENTION

The invention relates to a recreational vehicle, in particular a motorhome, with a belt support.

### BACKGROUND OF THE INVENTION

There are several disclosures of belt support arrangements, in particular for motorhomes, in various designs. For example, DE 20 2020 106 815 U1 discloses a belt support arrangement for a motorhome. The known belt support arrangement has a belt support and a restraint system. The restraint system comprises a belt system and a retaining fitting, arranged on the belt support, of a seat restraint for a child seat. Several individual retaining fittings are arranged separately from each other and independently next to each other on the belt support. The belt support arrangement has a base plate and an inclined support foot. The belt support is arranged to stand on the floor. The belt support can be attached to the floor and/or the chassis via a special support profile. The belt support is mounted on the side edge of the vehicle via a side member.

The belt support arrangement known from DE 20 2020 106 815 U1 has the disadvantage that the space under the floor is required for mounting the belt support. On the base plate and on the support foot, screw-on patterns are provided, which are used for screw fastening to the floor by means of several screw connections. The screw connections protrude into the space under the floor. In addition, through-holes must be drilled in the floor in accordance with the screw connection diagrams.

The object of the invention is to provide a recreational vehicle, in particular a motorhome, with at least one belt support, which has an improved structure and enables improved operation.

### SUMMARY OF THE INVENTION

The object is achieved by a recreational vehicle with the features disclosed herein. Advantageous further embodiments of the invention are also disclosed.

The object is achieved by a recreational vehicle, in particular a motorhome, having a vehicle frame and at least one belt support which is fastened at least indirectly to the vehicle frame, wherein a battery space is provided which is arranged at least partially inside the vehicle frame, wherein the belt support is arranged at least partially above the battery space, and wherein the belt support is connected to the vehicle frame in such a way that connecting elements which serve to connect the belt support to the vehicle frame are arranged outside the battery space. The term motorhome is to be understood broadly in the context of the present invention. For example, a campervan may be included in the term motorhome.

In a particularly preferred embodiment, the design of an electrically powered recreational vehicle can be realized in this way, in which at least one traction battery is arranged in the battery space. Here, the space under the floor, in particular the battery space, can be optimally utilized in order to use this drive concept and at the same time enable an improved design of the interior, as components can be accommodated in the vehicle frame.

It is advantageous that a battery space region of a floor is arranged above the battery space, which delimits the battery space and which is arranged at least partially between the belt support and the battery space, and the connecting elements are arranged outside the battery space region of the floor. This means that the region above the battery does not have to be drilled or modified during installation. Damage to this area is also prevented.

It is advantageous that the belt support has at least one support foot which is supported at least indirectly on the battery space region of the floor, that the support foot is arranged completely above the battery space region of the floor and that the support foot itself is at least not positively connected to the floor. This means that the support foot can be supported only on the floor without the floor having to be machined, for example by drilling. It is conceivable that components are arranged on the floor which are connected to the floor by adhesive, for example. However, it is also possible that drilling is provided in addition to the support foot. For example, a one-sided fastening based on drilling, e.g. by means of rivet nuts, may be provided.

It is advantageous that at least one torque support is provided, which is arranged at least partially above the battery space region of the floor, and that the torque support is supported at least indirectly on the battery space region of the floor. This enables an advantageous transmission of force without the need for connecting elements to protrude into the battery space or for the floor above the battery space to be modified.

It is advantageous, that the belt support is supported on the battery space region of the floor in such a way that, during operation, compressive and/or bending forces are introduced into the vehicle frame at least at the battery space region of the floor, at least by means of the floor. This allows high forces to be absorbed in the event of an impact, for example, without destroying the floor and thus damaging the protected battery space. The battery space thus provides a protective space for the battery.

It is advantageous that a floor plate is provided, which is arranged on the floor and at least partially covers the battery space region of the floor, and that the belt support is supported on the battery space region of the floor in such a way that, during operation, compressive and/or bending forces act on the floor by means of the floor plate. This allows the force acting on the floor to be distributed over the surface. In addition, the floor plate provides further protection for the battery space.

It is advantageous that at least one fastening device is provided, which engages around at least one element of the vehicle frame, and that the fastening device is arranged outside the battery space region. This allows a high degree of stability of the connection to be achieved. The belt support can therefore be arranged directly above the battery space.

It is advantageous that the fastening device engages around at least one element of the vehicle frame designed as a cross member of the vehicle frame and/or at least one element of the vehicle frame designed as a longitudinal member of the vehicle frame. This enables a reliable connection that can absorb high forces in the event of a vehicle impact.

It is advantageous that at least one fastening device has a connecting element designed as an upper retaining element and a connecting element designed as a lower retaining element, which are designed to be divided from one another, and/or that the fastening device is arranged at least partially, preferably at least substantially, to the side of the battery space area in relation to a vehicle's longitudinal direction. This enables advantageous mounting from the side. It is not necessarily necessary to remove and install the battery to realize the fastening.

Optionally, a side wall connection can be provided, which is attached and/or can be attached to a side wall of the recreational vehicle and is designed to connect the belt support to the side wall. The side wall connection can be part of the belt support. In particular, a side wall can be a wall of the recreational vehicle that is arranged laterally when viewed in the direction of travel or longitudinal direction of the vehicle. The side wall connection can be attached or attachable to the belt support. For example, the side wall connection can be essentially flat. Optionally, a main surface of the side wall connection can be provided essentially parallel to a surface of the side wall. The side wall connection may comprise at least one fastening means for fastening to the side wall. For example, the side panel connection may comprise at least one screw hole and/or a fastening clip mechanism. The side wall connection may be particularly advantageous for use in recreational vehicles designed as panel vans. However, use in other recreational vehicles is also conceivable.

It is advantageous that at least one battery is provided, which is arranged in the battery space. The battery space can serve as a protective space for the battery. If necessary, several batteries can also be arranged in the battery space. For example, a battery for the electrical supply of equipment, in particular lighting of an interior, sockets, a refrigerator and the like, can also be arranged in the battery space.

It is advantageous that at least one electric traction drive is provided and that at least one battery serving at least for the traction drive is provided, which is arranged in the battery space. The battery space can also be used exclusively for at least one traction battery.

It is advantageous that at least one crash element is provided, which serves to protect a battery arranged in the battery space in the event of a vehicle impact, and that the at least one crash element is arranged outside the battery space. This can further improve the protective function of the protective space for the battery. The crash element may, for example, be arranged between the battery space and a side wall of the leisure vehicle. The crash element may preferably be arranged at a height of the battery space. The crash element may be designed to absorb the crash forces acting on it, in particular lateral crash forces.

It is advantageous that load points are predetermined at which the connecting elements are connected to the vehicle frame. This enables an advantageous fastening that differs from conventional systems with load or seat rails that are used for fastening in the vehicle.

It is advantageous that the belt support is connected to the vehicle frame in such a way that tensile forces are only introduced into the vehicle frame outside the battery space area during operation. This provides a high level of protection for the battery located in the battery space.

It is advantageous that the vehicle frame and/or the belt support are designed in such a way that a battery does not have to be removed from the battery space during assembly and/or disassembly of the belt support. This design can be achieved in particular in conjunction with the fact that the belt support is arranged at least partially above the battery space, and that the belt support is connected to the vehicle frame in such a way that connecting elements used to connect the belt support to the vehicle frame are arranged outside the battery space. Such an arrangement means that it is not necessary to dismantle the battery, in particular a battery of the drive system, when installing the belt support. This enables a particularly easy assembly or disassembly the belt support.

Depending on the application, one or more of the following embodiments and advantages may be realized.

In a particularly preferred embodiment, a belt frame connection is realized for recreational vehicles that are designed as hybrid or battery electric motorhomes or campervans.

The recreational vehicle can be based on a base vehicle that is powered by a vehicle manufacturer (OEM) in series production. In a conventional design, in particular with a combustion engine, no prohibited space is specified by an OEM in the area of the side members. As a result, in a conventional design of a base vehicle for the expansion of the recreational vehicle, connections for belt frames can be positioned flexibly and grips around the side members or holes can be made almost anywhere. With a conventional base vehicle as the basis for the recreational vehicle, it is therefore possible to remove components such as tanks, and this is also used to create accessibility for assembly.

In contrast, it is conceivable for a battery electric drive that a prohibited space for the battery is specified by the OEM. This can represent the additional specification for the expansion that neither connecting elements may protrude into the prohibited space nor may the floor above the prohibited space be modified. In such a case, the proposed and possibly advantageously further developed solution can be used with such a base vehicle, even if a belt support is to be arranged above the battery, for example.

In particular, it is also possible to install the seat belt support if the vehicle frame is not accessible from both sides when the battery is already installed. In this case, an OEM specification, for example, that the area above the battery must not be damaged, drilled or modified during installation, can be adhered to. A favorable force transmission into the side members from below is made possible.

The use of battery electric vehicles (BEV) is particularly advantageous. However, use in other vehicles with a large battery in the prohibited space is also advantageous. The prohibited space may be the space specified by the OEM with the drive battery. Especially in the case of such a vehicle with a battery, it is possible that the connection of the belt frame (belt support) is not in the prohibited space of the drive battery.

Particularly in the case of a vehicle with a battery, the belt support can be connected to predetermined load points in the vehicle, for example for load rails, which sets it apart from conventional systems with load or seat rails.

Installation is possible without having to remove the battery in the prohibited space. Engaging around may be performed by an upper and a lower retaining element, which are divided to enable installation without removing the battery. A connection with engaging around at least one cross member outside the prohibited area is advantageous. For the most part, there can be one-sided accessibility during installation. In particular, only one-sided mounting may be provided on the prohibited space.

Above the prohibited space, support can only be provided on the floor, in particular the flooring, or a floor plate. A torque support can be provided. The term torque support is to be understood broadly here and includes supports, beams and square or polygonal tubes. The torque support can be used to absorb tensile, compressive and bending forces above the prohibited space.

Engaging around for fastening may take place exclusively under the floor panel, provided it does not take place in the prohibited or battery space. Preferably, a restricted space outside the battery space is designated for this purpose, in which the engaging around is carried out.

Crash elements of the battery can increase safety and be arranged in the restricted space. Tensile forces are preferably only introduced into the body or frame outside the prohibited or battery region. Compressive and bending forces are preferably introduced into the body or frame in the area above the battery.

This means that it is advantageously applicable to vehicles with batteries for the drive system.

### BRIEF DESCRIPTION OF THE DRAWINGS

Further advantages and details of the invention are explained in more detail with reference to the embodiments shown in the schematic figures. These show:

FIG. 1 is an excerpt from a schematic representation of a recreational vehicle according to a possible embodiment of the invention, wherein a vehicle frame is shown in a view from above;

FIG. 2 is a schematic, spatial representation of a belt support for the recreational vehicle shown in FIG. 1 according to an embodiment; and

FIG. 3 is an excerpt-wise, spatial representation a belt support for the recreational vehicle shown in FIG. 1 and the vehicle frame corresponding to a further embodiment, wherein a possible fastening is illustrated.

### DETAILED DESCRIPTION OF THE INVENTION

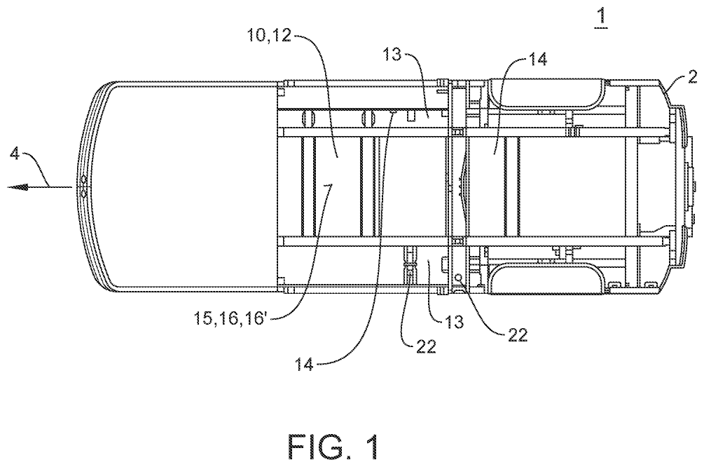

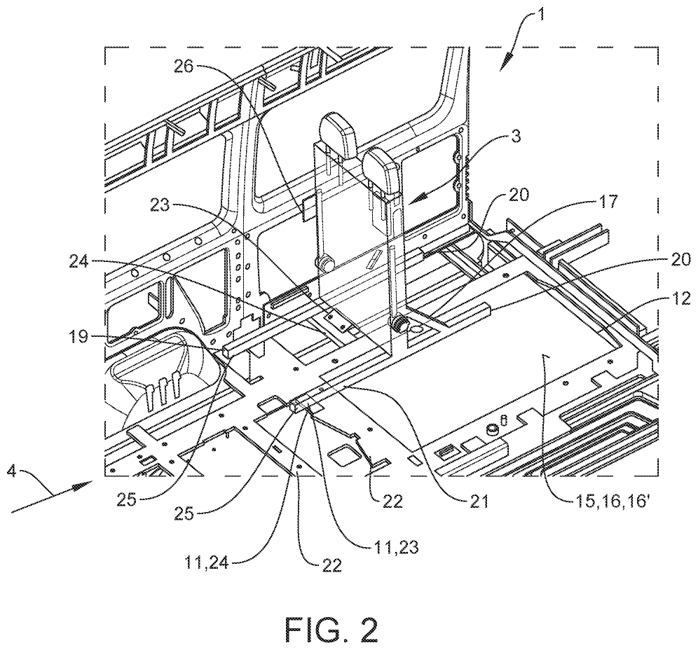

FIG. 1 shows an excerpt from a schematic representation of a recreational vehicle 1 in accordance with a possible embodiment of the invention, wherein a vehicle frame 2 is shown in a view from above. The recreational vehicle 1 is preferably designed as a motorhome. Furthermore, FIG. 2 shows a belt support 3 for the leisure vehicle 1 shown in FIG. 1 in a schematic, spatial representation according to an embodiment. The belt support 3 can be used for a rear, in particular a second or third, row of seats. The belt support 3 is attached to the vehicle frame 2.

A vehicle's longitudinal direction 4 is given for the recreational vehicle 1. In this embodiment, the belt support 3 is oriented in the vehicle's longitudinal direction 4 and therefore in the direction of travel. In a modified embodiment, however, the belt support 3 can also be oriented in the opposite direction to the vehicle's longitudinal direction 4.

A battery space 10 is also provided, which in this embodiment is arranged within the vehicle frame 2. The belt support 3 is arranged at least partially above the battery space 10. Connecting elements 11, some of which are shown by way of example, are used to connect the belt support 3 to the vehicle frame. The belt support 3 is connected to the vehicle frame 2 in such a way that all connecting elements 11 used to connect the belt support 3 to the vehicle frame 2 are arranged outside the battery space 10. Optionally, at least one side wall connection 26 can be provided for connecting the belt support 3 to a side wall of the recreational vehicle 1.

For example, an electric traction drive can be provided for the recreational vehicle 1. In this case, a battery 12 serving for the traction drive can be arranged in the battery space 10. Restricted spaces 13, 14 may be provided outside the battery space 10, with the restricted spaces 13 being arranged laterally next to the battery space 10 and the restricted space 14 being arranged behind the battery space 10 in the vehicle's longitudinal direction 4 of the vehicle. The restricted spaces 13, 14 can be used to secure the belt support 3. Crash elements can be arranged in the restricted spaces, but also elsewhere, which then serve to protect the battery 12 arranged in the battery space 10 in the event of a vehicle impact. The crash elements are preferably arranged outside the battery space 10.

A battery space region 15 of a floor 16 is arranged above the battery space 10. The battery space region 15 of the floor 16 delimits the battery space 10.

Furthermore, the battery 12 is arranged below the battery space region 15, while the belt support is arranged at least partially above the battery space region 15 of the floor and possibly partially next to the battery space region 15 of the floor 16. In particular, the connecting elements 11 are arranged outside the battery space region 15 of the floor 16.

In addition, a torque support 20 is provided, which is arranged above the battery space region 15 of the floor 16. The torque support 20 is supported on the battery space region 15 of the floor 16, so that the belt support 3 is reliably supported in the event of an impact (crash). In this configuration, the belt support 3 has an optional support foot 17. The support foot 17 is indirectly supported on the battery space region 15 of the floor 16 via a torque support 20. In this case, the support foot 17 is located completely above the battery space region 15 of the floor 16. It is optionally possible that no positive connection is provided between the support foot 17 and the floor 16.

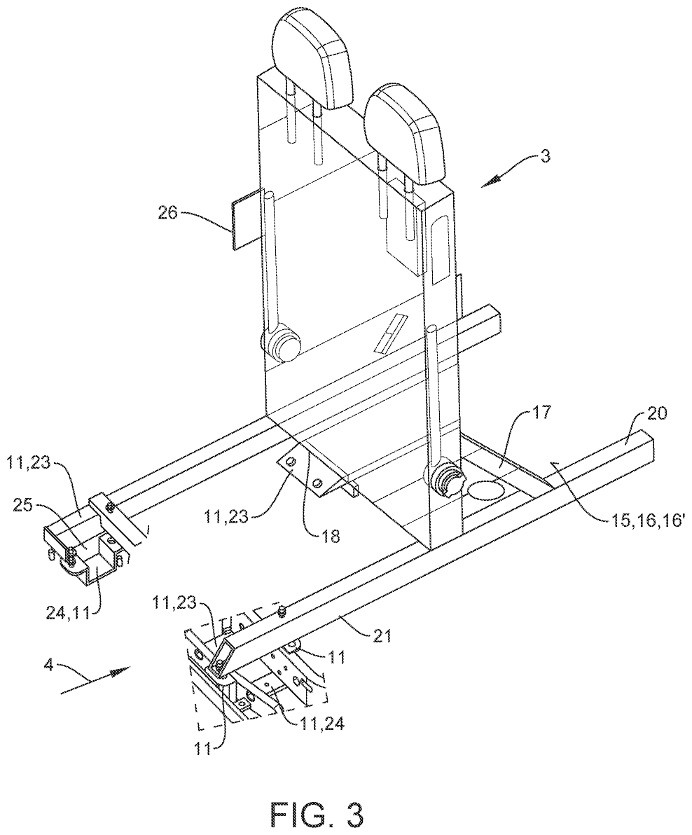

FIG. 3 shows a belt support 3 for the leisure vehicle 1 shown in FIG. 1 as well as the vehicle frame 2 in an excerpt-wise, spatial representation corresponding to an embodiment, wherein a possible fastening is illustrated. In the embodiment example in FIG. 3, fastening devices 21 are each provided with an upper retaining element 23 and a lower retaining element 24, which embrace an element 22 of the vehicle frame 2 designed as a cross member 22. The fastening devices 21 each comprise a connecting element 11 designed as an upper retaining element 23 and a connecting element 11 designed as a lower retaining element 24, which are divided from one another. Optionally, one of the fastening devices 21 is arranged laterally next to and thus outside the battery space region 15. Optionally, another of the fastening devices 21 is arranged in front of the battery space region 15 and thus outside the battery space area 15. In the embodiments shown in FIGS. 2 and 3, attachment to the cross member 22 behind the battery space region 15 is possible in a corresponding manner in each case.

This means that the belt support 3 can be connected to the vehicle frame 2 in such a way that tensile forces are only applied to the vehicle frame 2 outside the battery space region 15 during operation. In one embodiment, load points 25 can be predetermined at which the connecting elements 11 are connected to the vehicle frame 2. Load points 25 are marked by way of example. The load points 25 are located outside the battery space 10.

In addition, at least one torque support 20 is provided, which is arranged above the battery space region 15 of the floor 16. The torque support 20 is supported on the battery space region 15 of the floor 16, so that reliable support of the belt support 3 is provided in the event of an impact (crash). In this example, the at least one torque support 20 extends essentially in the longitudinal direction of the vehicle 4. In particular, the torque support 20 in the vicinity of the vehicle wall can optionally be omitted. Optionally, at least one support 19 is provided, in particular opposite the at least one torque support 20. In a modified embodiment, a floor plate can also be provided, on which the belt support 3 is supported on the floor 16 in the battery space region 15. The belt support 3 is then indirectly supported on the floor 16, namely by means of the floor plate.

Thus, for example, in the event of an impact, compressive and/or bending forces are introduced at least at the battery space region 15 of the floor 16 into the vehicle frame 2 by means of the floor 16. If a floor panel 16′ is provided, the compressive and/or bending forces act on the floor 16 by means of the floor panel 16′.

In this embodiment, the belt support 3 has a support foot 17. The support foot 17 is indirectly supported on the battery space region 15 of the floor 16 via a torque support 20. In this case, the support foot 17 is located completely above the battery space region 15 of the floor 16. In particular, no positive connection is provided between the support foot 17 and the floor 16. Alternatively, however, it is also possible to provide a positive connection between the support foot 17 and the floor 16. The support foot 17 can interact with the torque supports 20, in particular to enable transmission of forces in the longitudinal direction of the vehicle 4, which act on the belt support 3, into the vehicle floor.

The invention is not limited to the embodiments described.

1-11. (canceled)

12. A recreational vehicle, comprising:
a vehicle frame;
at least one belt support which is fastened at least indirectly to the vehicle frame;
connecting elements, which serve to connect the at least one belt support to the vehicle frame; and
a battery space arranged at least partially inside the vehicle frame;
wherein;
the belt support is arranged at least partially above the battery space; and
the belt support is connected to the vehicle frame in such a way that the connecting elements are arranged outside the battery space.

13. The recreational vehicle according to claim 12, wherein:
a battery space region of a floor is arranged above the battery space, the battery space region of the floor delimiting the battery space and arranged at least partially between the at least one belt support and the battery space; and
the connecting elements are arranged outside the battery space region of the floor.

14. The recreational vehicle according to claim 13, wherein:
the at least one belt support has at least one support foot which is supported at least indirectly on the battery space region of the floor;
the at least one support foot is arranged completely above the battery space region of the floor; and
the at least one support foot is at least not positively connected to the floor.

15. The recreational vehicle according to claim 13, further comprising:
at least one torque support arranged at least partially above the battery space region of the floor;
wherein the at least one torque support is supported at least indirectly on the battery space region of the floor.

16. The recreational vehicle according to claim 13, wherein the at least one belt support is supported on the battery space region of the floor in such a way that, during operation, compressive and/or bending forces are introduced into the vehicle frame at least at the battery space region of the floor at least by means of the floor.

17. The recreational vehicle according to claim 13, further comprising a floor plate arranged on the floor and at least partially covering the battery space region of the floor, the at least one belt support being supported on the battery space region of the floor in such a way that, during operation, compressive and/or bending forces act on the floor by means of the floor plate.

18. The recreational vehicle according to claim 13, further comprising at least one fastening device which engages around at least one element of the vehicle frame, the at least one fastening device being arranged outside the battery space region.

19. The recreational vehicle according to claim 18, wherein the at least one element of the vehicle frame comprises a cross member of the vehicle frame, and the at least one fastening device engages around the cross member.

20. The recreational vehicle according to claim 18, wherein the at least one fastening device has a connecting element designed as an upper retaining element and a connecting element designed as a lower retaining element, the upper and lower retaining elements being designed to be divided from one another.

21. The recreational vehicle according to claim 18, wherein the fastening device is arranged at least partially to a side of the battery space region with respect to the vehicle's longitudinal direction.

22. The recreational vehicle according to claim 12, further comprising at least one battery arranged in the battery space.

23. The recreational vehicle according to claim 12, further comprising:
at least one electric traction drive; and
at least one battery serving at least for the traction drive arranged in the battery space.

24. The recreational vehicle according to claim 12, further comprising at least one crash element, which in the event of a vehicle impact serves to protects a battery arranged in the battery space, the at least one crash element being arranged outside the battery space.

25. The recreational vehicle according to claim 12, wherein load points are predetermined at which the connecting elements are connected to the vehicle frame.

26. The recreational vehicle according to claim 12, wherein the at least one belt support is connected to the vehicle frame in such a way that tensile forces are only introduced into the vehicle frame outside the battery space area during operation.

27. The recreational vehicle according to claim 12, wherein the vehicle frame and/or the at least one belt support are designed in such a way that a battery does not have to be removed from the battery space during assembly and/or disassembly of the belt support.

28. The recreational vehicle according to claim 12, wherein the recreational vehicle is a motorhome.

29. A recreational vehicle, comprising:
a vehicle frame;
at least one belt support which is fastened at least indirectly to the vehicle frame;
connecting elements, which serve to connect the at least one belt support to the vehicle frame; and
a battery space arranged at least partially inside the vehicle frame;
a battery space region of a floor is arranged above the battery space, the battery space region of the floor delimiting the battery space and arranged at least partially between the at least one belt support and the battery space;
at least one electric traction drive; and
at least one battery serving at least for the traction drive arranged in the battery space;
wherein;
the belt support is arranged at least partially above the battery space; and
the belt support is connected to the vehicle frame in such a way that the connecting elements are arranged outside the battery space and outside the battery space region of the floor.

30. The recreational vehicle according to claim 29, further comprising at least one crash element, which in the event of a vehicle impact serves to protects the battery arranged in the battery space, the at least one crash element being arranged outside the battery space.

31. The recreational vehicle according to claim 30, wherein the at least one belt support is connected to the vehicle frame in such a way that tensile forces are only introduced into the vehicle frame outside the battery space area during operation.
